(19) United States
(12) Patent Application Publication
(10) Pub. No.: US 2008/0263160 A1
(43) Pub. Date: Oct. 23, 2008

(54) METHOD FOR DISPLAYING CONTENT INFORMATION AND VIDEO APPARATUS THEREOF

(75) Inventor: Jung-yon CHO, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/863,320

(22) Filed: Sep. 28, 2007

(30) Foreign Application Priority Data
Apr. 20, 2007 (KR) 10-2007-38570

(51) Int. Cl. G06F 17/30; G06F 15/16

(52) U.S. Cl. 709/206; 707/104.1; 707/E17.009

(57) ABSTRACT

A method for displaying content information and a video apparatus thereof are provided. The video apparatus includes an interface unit which receives a mail message from a mail server; and a content information generator which generates content information using a mail body of the received mail message, if URL information is contained in the mail body. Therefore, content such as web pages may also be provided to a user who does not know a URL, and the user can easily access content using a video apparatus in which it is difficult to perform web browsing.

### CROSS-REFERENCE TO RELATED APPLICATIONS

This application claims priority under 35 U.S.C. § 119 from Korean Patent Application No. 10-2007-0038570, filed on Apr. 20, 2007, in the Korean Intellectual Property Office, the disclosure of which is incorporated herein by reference in its entirety.

### BACKGROUND OF THE INVENTION

1. Field of the Invention

Apparatuses and methods consistent with the present invention relate to displaying content information, and more particularly, to displaying content information together with content corresponding to the content information.

2. Description of the Related Art

The recent development and popularization of the Internet has led to the emergence of televisions (hereinafter referred to as “Internet TVs”) that can be connected to the Internet to perform web browsing. Accordingly, web browsing can be performed via Internet TVs, instead of personal computers (PCs).

However, users need to know uniform resource locators (URLs) used as addresses of web pages, even if TVs are capable of web browsing. Additionally, even if users know URLs, TVs are operated through key input devices such as remote controllers, instead of computer mice, so it is difficult to perform web browsing.

A method is also available for performing web browsing using a wireless mouse, but this method causes additional incidental expenses. Additionally, there is a need for a flat surface in order to use the wireless mouse, but Internet TV viewing is not performed on a flat surface such as a desk in the manner of a PC.

Furthermore, since users still need to know URLs even when browsing using the wireless mouse as described above, Internet TVs have little practical use for TV users who are not familiar with the Internet.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method for displaying content information and a video apparatus thereof, which provides a user who does not know a uniform resource locator (URL) with content such as web pages, thus increasing user convenience.

According to an aspect of the present invention, there is provided a video apparatus comprising an interface unit which receives a mail message from a mail server; and a content information generator which generates content information using a mail body of the received mail message, if uniform resource locator (URL) information is contained in the mail body.

The content information generator may comprise a mail receiver which receives a mail message from the interface unit; a content information extractor which extracts content information from a mail body of the mail message received by the mail receiver; and a content information constructor which constructs a content information list based on the extracted content information.

The interface unit may transmit a mail request message to the mail server and receive a mail message from the mail server, if a content information display command is input.

The interface unit may transmit a content request message to a content provider and receive content corresponding to the content request message, if a content display command is input.

The content information may comprise at least one of the title, summary, category, author, sender and a URL, relating to the content.

The mail message may be written by at least one of a user and a content provider.

The video apparatus may have a specific mail address, and the mail server may send a mail message to the video apparatus having the specific mail address.

The video apparatus may comprise a broadcast receiver.

The mail body may be written in extensible markup language (XML).

According to another aspect of the present invention, there is provided a video apparatus comprising an interface unit which receives a mail message from the mail server; a content information generator which generates content information using a mail body of the received mail message; a storage unit which stores the content information generated by the content information generator; and a controller which generates a content information list based on the content information stored in the storage unit, if a content information display command is input.

According to another aspect of the present invention, there is provided a control method of a video apparatus, the method comprising receiving a mail message from a mail server; determining whether uniform resource locator (URL) information is contained in a mail body of the received mail message; and generating content information using the mail body of the received mail message, if it is determined that the URL information is contained in the mail body.

The method may further comprise transmitting a content request message to a content provider, if a content display command is input; and receiving content in response to the content request message.

The content information may comprise at least one of the title, summary, category, author, sender and a URL, relating to the content.

The mail message may be written by at least one of a user and a content provider.

The method may further comprise storing the generated content information; and generating a content information list based on the stored content information, if a content information display command is input.

The generating the content information may comprise generating content information if information related to a URL is contained in the received mail message.

The video apparatus may have a specific mail address, and the mail server may send a mail message to the video apparatus having the specific mail address.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a view schematically showing the relationship between devices connected via an Internet network, according to an exemplary embodiment of the present invention;

FIG. 2 is a block diagram of a video apparatus according to an exemplary embodiment of the present invention;

FIG. 3 is a flowchart explaining a process for receiving a mail message, generating content information based on the mail message and displaying content using the content information, according to an exemplary embodiment of the present invention;

FIG. 4 is a view showing a content information list according to an exemplary embodiment of the present invention; and

FIG. 5 is a block diagram of a video apparatus according to another exemplary embodiment of the present invention.

### DETAILED DESCRIPTION OF EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

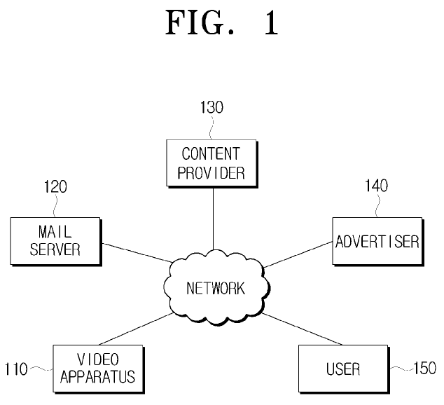

FIG. 1 is a view schematically showing the relationship between devices connected via an Internet network, according to an exemplary embodiment of the present invention. In FIG. 1, a video apparatus 110, a mail server 120, a content provider 130, an advertiser 140 and a user 150 transmit and receive information via the Internet. First, the content provider 130, advertiser 140 or user 150 writes a mail message comprising content information, and transmits the mail message to the mail server 120. The mail server 120 then transmits the mail message to the video apparatus 110 having an address for a specific mail message. The video apparatus 110 which receives the mail message generates content information based on a mail body of the received mail message, and displays the content information.

If a user desires to view content (for example, web pages) corresponding to the content information using the video apparatus 110, the video apparatus 110 may generate a content request message and transmit the content request message to the content provider 130, and then the content provider 130 may output content to the video apparatus 110. Accordingly, content may be provided to the user through the video apparatus 110, even if the user does not know a web page address.

Additionally, although it is not as easy to perform web browsing in the video apparatus 110 as it is to receive broadcasts, the user may be conveniently provided with the content.

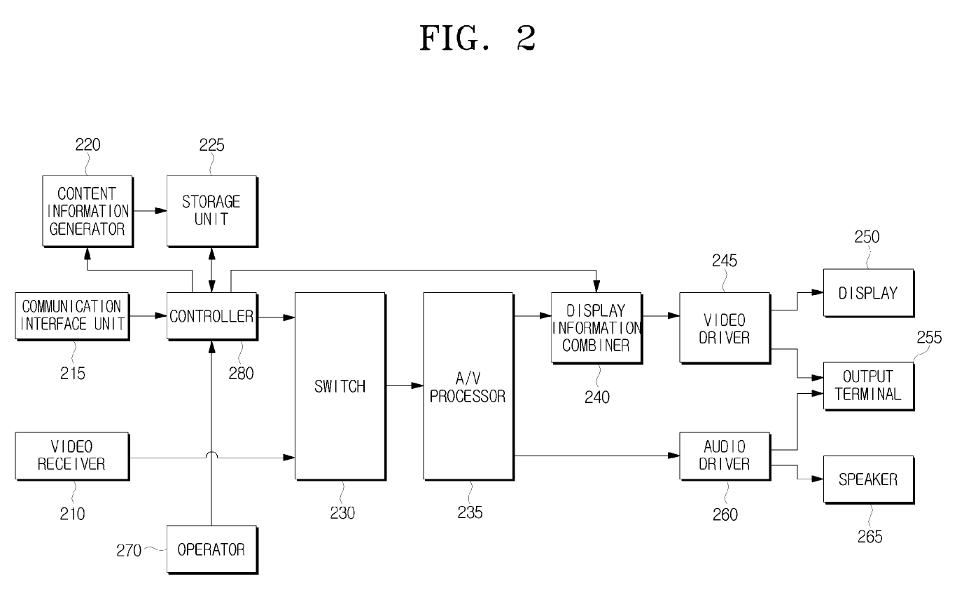

FIG. 2 is a block diagram of the video apparatus 110 according to an exemplary embodiment of the present invention. In FIG. 2, the video apparatus 110 comprises a video receiver 210, a communication interface unit 215, a content information generator 220, a storage unit 225, a switch 230, an audio/video (A/V) processor 235, a display information combiner 240, a video driver 245, a display 250, an output terminal 255, an audio driver 260, a speaker 265, an operator 270 and a controller 280.

The video receiver 210 receives video data from an external apparatus. Specifically, the video receiver 210 receives a broadcasting signal via an antenna, a cable, or other devices. Additionally, the video receiver 210 may receive video data from a digital camera, a digital camcorder, a personal computer (PC) or other device.

The communication interface unit 215 transmits and receives data to and from an external apparatus via the Internet. Specifically, the communication interface unit 215 receives a mail message from the mail server 120 or receives content from the content provider 130, and transfers the received mail message and content to the controller 280. Additionally, the communication interface unit 215 may transmit a content request message to the content provider 130 via the Internet.

The content information generator 220 generates content information based on the body of the received mail message. In other words, if the mail message includes content information regarding a uniform resource locator (URL), the content information generator 220 may create content information associated with the URL.

The content information may comprise at least one of the title, summary, category, author, sender and a URL, relating to the content, so that a user can understand the nature of the content only by viewing the content information. The content information is naturally contained in the content of the mail message.

Additionally, the content information generator 220 stores in the storage unit 225 the content information, the URL indicating the content information, and index information linking between the content information and the URL. Accordingly, if a user inputs a content display command, the URL indicating the content information can be easily read. If there is a plurality of pieces of content information, the content information generator 220 may assign designated numbers to each piece of content information.

The content information generator 220 may store the content information in the storage unit 225 in the order in which mail messages are received, or according to the category of the content information.

The switch 230 performs switching so that one of the video data received by the video receiver 210 and the video data received by the communication interface unit 215 may be output to the A/V processor 235, under the control of the controller 280. The A/V processor 235 processes the video data (video signal/audio signal) transferred from the switch 230 so that the video data can be played back. Additionally, the A/V processor 235 sends the video signal and the audio signal to the display information combiner 240 and the audio driver 260, respectively.

The display information combiner 240 combines display information, such as characters, symbols, figures and graphics, with the video output from the A/V processor 235. In this case, the display information combiner 240 can combine the display information by using an on-screen display (OSD) method. The combining operation of the display information combiner 240 is controlled by the controller 280.

The video driver 245 displays the video combined with the display information output from the display information combiner 240 on the display 250, or transmits the video to another external apparatus (not shown) connected through the output terminal 255.

The audio driver 260 outputs the audio signal output from the A/V processor 235 through the speaker 265, or transmits the audio signal to another external apparatus (not shown) connected through the output terminal 255.

The operator 270 may be provided integrally with or separately from the video apparatus 110, and may receive operating commands from a user and transmit the commands to the controller 280. Additionally, the operator 270 may be implemented as a user interface through which a user can enter the commands using a menu screen. The operator 270 may also comprise a remote controller for a user to input the operating commands, and a light receiver which receives an output signal of the remote controller to transmit the signal to the controller 280. The remote controller may include number keys “0” to “9”, or up/down/left/right direction keys “▴/▾/

[symbol]

[symbol]

The controller 280 controls the operation of the video apparatus 110 according to the operating commands of a user which are entered through the operator 270.

In particular, the controller 280 controls the video apparatus 110 to play back the video data transferred from the video receiver 210. Additionally, the controller 280 determines whether the data received through the communication interface unit 215 is a mail message or content. If the received data is a mail message, the controller 280 may transfer the mail message to the content information generator 220, and if the received data is content, the controller 280 may send the content to the A/V processor 235.

Additionally, if a content information display command is input through the operator 270, the controller 280 may read the content information stored in the storage unit 225, may generate a content information list, and may transfer the content information list to the display information combiner 240, so that the content information list can be displayed.

If a content display command is input through the operator 270, the controller 280 may generate a content request message, and may transmit the content request message to the content provider 130 through the communication interface unit 215. The content request message may comprise a URL associated with the content.

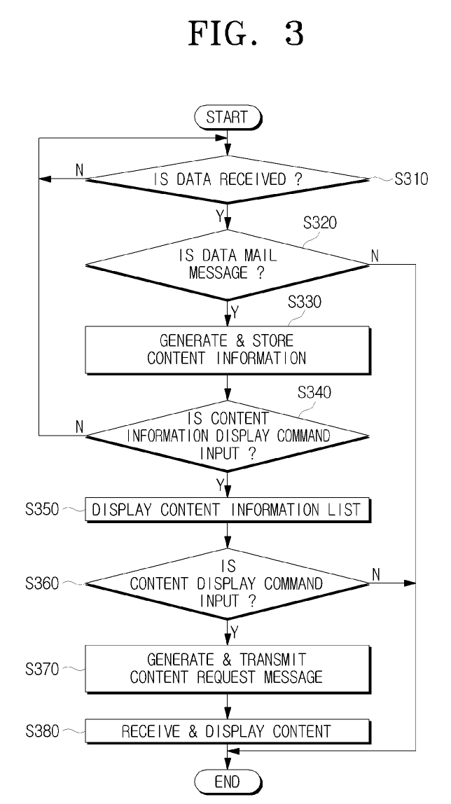

Hereinafter, a process by which the video apparatus 110 displays content using content information will be described in more detail with reference to FIG. 3. FIG. 3 is a flowchart explaining a process for receiving a mail message, generating content information based on the mail message and displaying content using the content information, according to an exemplary embodiment of the present invention.

If it is determined that data is received through the communication interface unit 215 (S310-Y), the controller 280 may determine whether the received data is a mail message or not (S320). Specifically, the content provider 130, advertiser 140 or user 150 may write a mail message related to content and transmit the mail message to the video apparatus 110 through the mail server 120. The controller 280 of the video apparatus 110 may determine whether the received data is a mail message or not, based on packet information of the received data. Since the data is received from the mail server 120, the received data may be determined to be mail message.

If the received data is determined to be a mail message (S320-Y), the controller 280 may transfer the received data to the content information generator 220, and may then control the content information generator 220 to generate content information (S330). In other words, if the content information generator 220 receives the data from the controller 280, the content information generator 220 may generate content information based on the mail body. The mail body may comprise a URL. If a URL is not directly included in the mail body, but the mail body comprises a link, the content information generator 220 may determine that the URL is contained in the mail body.

The content information generator 220 may create content information, so that the content information may comprise at least one of the title, summary, category, author/sender and a URL, relating to the content. Additionally, the content information generator 220 may store in the storage unit 225 the content information, URL, and index information linking between the content information and the URL.

The controller 280 determines whether the content information display command is input (S340). A user may input the content information display command so that the content information can be displayed through a menu list, while viewing broadcasting or video stored in an external apparatus through the video apparatus 110.

If it is determined that the content information display command is input (S340-Y), the video apparatus 110 may display the content information list (S350). Specifically, the controller 280 may read the content information stored in the storage unit 225. The content information list may be generated by assigning numbers to each piece of content information in the order in which the content information is generated, and the generated content information list may be transferred to the display information combiner 240. The display information combiner 240 may then combine the content information list with video that can be displayed on the display 250, and the display 250 may display the combined content information list.

The controller 280 determines whether a content display command to display content corresponding to specific content information is input (S360). A user may input a command to display content associated with specific content information selected from the content information list displayed on the display 250. Specifically, specific numbers are assigned in the content information list, so the user can input the number assigned to the content he or she desires to view through the operator 270. Accordingly, the controller 280 may determine that the command to display content corresponding to specific content information is input.

If it is determined that the content display command is input (S360-Y), the controller 280 may generate a content request message, and may transmit the content request message to the content provider 130 through the communication interface unit 215 (S370). The content request message generated by the controller 280 may include the URL associated with the content information.

The video apparatus 110 receives content from the content provider 130 and displays the content (S380). In other words, if the content request message is received from the video apparatus 110, the content provider 130 may transmit content corresponding to the content request message to the video apparatus 110. The controller 280 of the video apparatus 110 may then determine whether the received data is a mail message or content. At this time, the data is received from the content provider 130, so the received data may be determined to be content. Additionally, the received content may be sent to the A/V processor 235 or the display information combiner 240 according to whether the received data represents video or text, and then the content may be subjected to signal processing and the processed content may be displayed.

If a mail message is received from the mail server 120, the video apparatus 110 may gain content information contained in the mail body and may display only the gained content information, not the received mail message. If a specific command is separately input, content may be received from the content provider 130 and may be displayed, and accordingly the video apparatus 110, in which it is not easy to browse web pages, can also display content easily, thereby increasing user convenience.

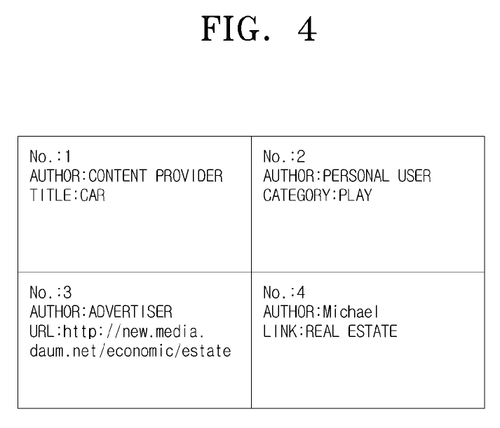

FIG. 4 is a view showing a content information list according to an exemplary embodiment of the present invention. As can be seen, if the content information list is displayed on the display 250, a user may view the content information, and may understand the nature of the content. If the user desires to display specific content using the video apparatus 110, the user may input a number assigned to the content information representing the specific content through the operator 270. The controller 280 may determine that the content display command is input. If a cursor is displayed on the display 250, the user may select specific content information using the up/down/left/right direction keys “▴/▾/ [symbol] [symbol] of the operator 270. In this situation, an area in which the specific content information is displayed may be linked.

Although if the user or other providers write a mail message including content information and transmit the mail message to the mail server 120, the mail server 120 may transmit the mail message to the specific video apparatus 110 in the exemplary embodiment of the present invention, the exemplary embodiment of the present invention is not limited thereto. For example, the user or other providers can directly transmit URL information to the video apparatus 110 having a specific address via the Internet. Next, the controller 280 of the video apparatus 110 may determine whether the received data is URL information, and then if the received data is determined to be URL information, content information may be generated.

Additionally, the exemplary embodiment of the present invention provides that the controller 280 may generate a content information list by assigning numbers to each piece of content information in the order in which content information is generated, but the present invention is not limited thereto. For example, the controller 280 may group the content information according to categories to which the content information belongs in order that a user can easily distinguish the content information, and may thus generate a content information list.

Furthermore, the mail server 120 in the exemplary embodiment of the present invention transmits the mail message to the video apparatus 110, but the present invention is not limited to such a configuration. The mail server 120 may continue to store mail messages which are transmitted to mail addresses of the video apparatus 110 by the user, content provider or the like, and if the video apparatus 110 requests to receive a mail message, the mail server 120 may transmit the mail messages to the video apparatus 110.

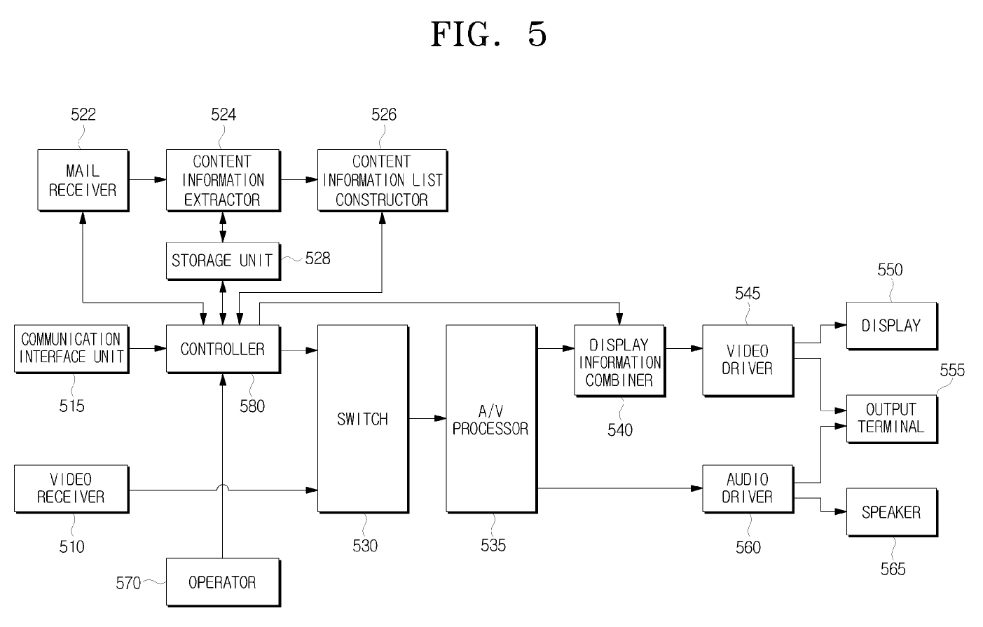

FIG. 5 is a block diagram of a video apparatus according to another exemplary embodiment of the present invention. In FIG. 5, a user may input a content information display command through an operator 570. A controller 580 may then transmit a content information request message to the mail server 120, and the mail server 120 may transmit a mail message in a mail account to the video apparatus 110. The mail account may comprise a single mail message or a plurality of mail messages, but in the exemplary embodiment of the present invention a plurality of mail messages exist in the mail account.

If it is determined that data is received from the mail server 120 through a communication interface unit 515, the controller 580 may transfer the received data to a mail receiver 552. The mail receiver 552 may transfer only a mail body of the mail message to a content information extractor 524.

The content information extractor 524 extracts content information from each mail body. Before the content information extractor 524 extracts the content information, the content information extractor 524 determines whether the mail body comprises URL information. In other words, if URL information is not contained in the mail body, it is impossible to generate a link, so there is no need for the content information extractor 524 to extract content information. However, if URL information is contained in the mail body, the content information extractor 524 may extract content information comprising at least one of the title, summary, category, author, sender and a URL, relating to the content from the mail body, and may then transfer the extracted content information to a content information list constructor 526. The mail body may be written in extensible markup language (XML).

The content information list constructor 526 constructs a content information list using the content information transferred from the content information extractor 524, so that a user can easily distinguish the content information. In other words, the content information list constructor 526 may group the content information with similar pieces of content so that a user can easily distinguish the content information, instead of only arranging the received content information. Alternatively, if there is a plurality of pieces of the same content information, the content information list constructor 526 may construct a list so that one of the plurality of pieces of the same content information can be contained in the list. Subsequently, the content information list is sent to the controller 580, and the controller 580 controls various function blocks of the video apparatus 110 so that the content information list can be displayed.

A video receiver 510, a communication interface unit 515, a storage unit 528, a switch 530, an A/V processor 535, a display information combiner 540, a video driver 545, a display 550, an output terminal 555, an audio driver 560, a speaker 565, an operator 570 and a controller 580, as shown in FIG. 5, have the same functions as the video receiver 210, communication interface unit 215, storage unit 225, switch 230, A/V processor 235, display information combiner 240, video driver 245, display 250, output terminal 255, audio driver 260, speaker 265, operator 270 and controller 280, as shown in FIG. 2, so detailed descriptions thereof are omitted. Although the controller 280 shown in FIG. 2 generates a content information list, the video apparatus according to the exemplary embodiment of the present invention of FIG. 5 comprises the content information list constructor 526, so the content information list constructor 526 constructs a content information list, instead of the controller 580 shown in FIG. 5.

The process for generating content information based on the mail body received from the mail server 120 and selecting the content information so that specific content can be displayed was described above. Additionally, this process may be used in the video apparatus 110 capable of receiving broadcasting. However, the video apparatus 110 is only an exemplary embodiment for convenience of description. Accordingly, the present invention is not limited to the video apparatus 110. For example, the present invention can be applied to a television (TV), a set-top box, a digital versatile disc (DVD) player, a DVD recorder, a video cassette recorder (VCR), a multimedia player, a moving picture player, a compact disk (CD) player, a CD recorder, a moving picture experts group-1 audio layer 3 (MP3) player, a mobile phone, a personal digital assistant (PDA) and an audio system, and a combination system comprising any combination thereof.

According to the present invention as described above, content, for example web pages, may also be provided to a user who does not know a URL, thus increasing user convenience. Additionally, the user can easily access content in a video apparatus in which it is difficult to perform web browsing.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A video apparatus comprising:
an interface unit which receives a mail message from a mail server; and
a content information generator which generates content information using a mail body of the received mail message, if uniform resource locator (URL) information is contained in the mail body.

2. The apparatus as claimed in claim 1, wherein the content information generator comprises:
a mail receiver which receives a mail message from the interface unit;
a content information extractor which extracts content information from a mail body of the mail message received by the mail receiver; and
a content information constructor which constructs a content information list based on the extracted content information.

3. The apparatus as claimed in claim 1, wherein the interface unit transmits a mail request message to the mail server and receives a mail message from the mail server, if a content information display command is input.

4. The apparatus as claimed in claim 1, wherein the interface unit transmits a content request message to a content provider and receives content corresponding to the content request message, if a content display command is input.

5. The apparatus as claimed in claim 1, wherein the content information comprises at least one of a title, summary, category, author, sender and a URL relating to the content.

6. The apparatus as claimed in claim 1, wherein the mail message is written by at least one of a user and a content provider.

7. The apparatus as claimed in claim 1, wherein the video apparatus has a specific mail address, and the mail server sends a mail message to the video apparatus having the specific mail address.

8. The apparatus as claimed in claim 1, wherein the video apparatus comprises a broadcast receiver.

9. The apparatus as claimed in claim 1, wherein the mail body is written in extensible markup language (XML).

10. A video apparatus comprising:
an interface unit which receives a mail message from a mail server;
a content information generator which generates content information using a mail body of the received mail message;
a storage unit which stores the content information generated by the content information generator; and
a controller which generates a content information list based on the content information stored in the storage unit, if a content information display command is input.

11. A control method of a video apparatus, the method comprising:
receiving a mail message from a mail server;
determining whether uniform resource locator (URL) information is contained in a mail body of the received mail message; and
generating content information using the mail body of the received mail message, if it is determined that the URL information is contained in the mail body.

12. The method as claimed in claim 11, further comprising:
transmitting a content request message to a content provider, if a content display command is input; and
receiving content in response to the content request message.

13. The method as claimed in claim 11, wherein the content information comprises at least one of a title, summary, category, author, sender and a URL, relating to the content.

14. The method as claimed in claim 11, wherein the mail message is written by at least one of a user and a content provider.

15. The method as claimed in claim 11, further comprising:
storing the generated content information; and
generating a content information list based on the stored content information, if a content information display command is input.

16. The method as claimed in claim 11, wherein the generating the content information comprises generating content information if information related to a URL is contained in the received mail message.

17. The method as claimed in claim 11, wherein the video apparatus has a specific mail address, and the mail server sends a mail message to the video apparatus having the specific mail address.
